(19) United States
(12) Patent Application Publication
(10) Pub. No.: US 2017/0146190 A1
(43) Pub. Date: May 25, 2017

(54) USED OIL PROCESSING ARRANGEMENT FOR A CIRCULAR KNITTING MACHINE

(71) Applicant: SIPRA Patententwicklungs-und Beteiligungsgesellschaft mbH, ALBSTADT (DE)

(72) Inventors: ZORAN RAIC, BURLADINGEN (DE); WOLFGANG BAUER, KORNWESTHEIM (DE); MICHAEL HERRE, BALINGEN (DE)

(21) Appl. No.: 15/323,457

(22) PCT Filed: Jun. 2, 2015
(86) PCT No.: PCT/EP2015/062232

§ 371 Date: Jan. 3, 2017

(30) Foreign Application Priority Data
Jul. 3, 2014 (DE) 10 2014 109 303.8

(51) Int. Cl. F16N 39/06; D04B 35/28; F16N 21/00; F16N 19/00; F16N 7/38

(52) U.S. Cl. CPC F16N 39/06; F16N 19/006; F16N 7/38; F16N 21/00; D04B 35/28; F16N 2210/32

(57) ABSTRACT

A used oil reprocessing arrangement for a circular knitting machine includes a used oil collection container for collecting used oil from the machine, a storage container for filtered used oil and new oil, a connecting conduit arranged between the used oil collection container and the storage container and at least one filter device. Level meters are provided in both containers and are connected to a control device, with which an oil feed pump (18) of the used oil collection container can be actuated.

Circular knitting machines need quite substantial quantities of oil in particular to lubricate needles and sinkers moving at high speeds and thus counteract premature wear of these components.

The used oil generated in the machine has hitherto been disposed of or reprocessed in an external purification unit.

The object forming the basis of the present invention is to provide a possibility for reprocessing used oil on a circular knitting machine to enable the oil consumption of the machine to be reduced.

The object is achieved by a used oil reprocessing arrangement for a circular knitting machine with a used oil collection container for collecting the used oil from the machine and with a storage container for filtered used oil and new oil, and also a connecting conduit between the containers and at least one filter device, wherein level meters are provided in both containers and are connected to a control device, with which an oil feed pump of the used oil collection container can be actuated. In this case, the connecting conduit can preferably be directed via a filter device. In addition, the used oil collection container and the storage container for filtered used oil and new oil can also be configured as separate chambers of a joint container.

The arrangement according to the invention allows a fully automatic reprocessing of the used oil, which when is stored in purified form in the fresh oil container and fed to the circular knitting machine once again. This enables savings in oil consumption of up to 30% to be achieved. This is associated with a substantial cost saving, not least as a result of the expensive disposal of used oil.

In an advantageous configuration of the arrangement a coarse filter for the collected used oil of the knitting machine is arranged at an inlet of the used oil collection container. Coarse dirt particles are thus held back and do not pass into the used oil collection container. The coarse filter can be removed through the inlet and cleaned or replaced, as required.

Further advantages result if at least one magnet is arranged in the used collection container to separate the metal components in the used oil. For this, one or more magnetic rods are preferably arranged in the region of the inlet of the used oil collection container. The used oil only comes back out of the machine in very small quantities in droplet form. These droplets flow along the magnetic rods. The metal components contained therein then adhere to the surface of the rods.

As a further precleaning measure the oil feed pump of the used oil collection container can aspirate the oil through a fine filter. The filter device in the connecting conduit to the fresh oil container is thus subject to reduced load and does not clog so quickly.

In a possible configuration of the used oil reprocessing arrangement an oil feed pump is also arranged in the fresh oil container to feed the oil to the knitting machine. However, the oil feed pump could also be positioned outside the fresh oil container.

Since part of the oil is consumed by the machine, it is necessary to also feed new oil to the machine in addition to the reprocessed oil. For this, the fresh oil container can have an inlet with a coarse filter downstream for manual replenishing with new oil. The coarse filter ensures that no contaminants pass into the fresh oil container during replenishing with new oil.

Further advantages can be achieved if a flow monitoring device is arranged in the connecting conduit. The flow monitoring device can also be coupled to the control device. The control device can then deactivate the oil feed pump of the used oil collection container when the flow monitoring device detects no or only a very small flow of oil in the connecting conduit as a result of clogging of the filter. Moreover, in the case of a decreasing flow as a result of clogging of the filter a warning signal can be emitted to indicate that the filter needs to be changed.

To prevent the used oil collection container from overflowing, the control device can activate the oil feed pump of the used oil collection container if the level meter detects that a maximum value for the oil level has been reached in the used oil collection container. Used oil is now directed through the filter device into the fresh oil container.

It is also possible to prevent the fresh oil container from overflowing by deactivating the oil feed pump of the used oil collection container if the level meter in the fresh oil container detects that a maximum value for the oil level in the fresh oil container has been exceeded.

Moreover, the control device can deactivate the oil feed pumps in both containers if the level meter in the respective container detects that the oil level has gone below a minimum value. As a result of this, the pumps can be reliably prevented from running empty.

If the level meter measures the exact oil level in the new oil, then it can be ensured that the mixture ratio between reprocessed used oil and new oil is kept constant, i.e. there are always sufficient additives in the new oil fed to the knitting machine.

However, a third container for new oil can also be provided, which is connected to the fresh oil container and has an oil feed pump connected to the control device. The control device can then activate the oil feed pump in the third container in such a manner that there is constantly more new oil than reprocessed oil in the fresh oil container, wherein the addition of reprocessed used oil from the used oil collection container and new oil from the third container is measurable by means of flow meters. In this case, the control device can also adjust the mixture ratio between reprocessed used oil and new oil to a constant value.

The invention additionally relates to a circular knitting machine with a used oil reprocessing arrangement according to the invention, wherein the used oil reprocessing arrangement is arranged on the frame of the circular knitting machine.

In this case, the used oil feed arrangement on the circular knitting machine can preferably be capable of being retrofitted so that machines that are already in operation can also be converted to a circular knitting machine according to the invention.

A preferred configuration of a used oil reprocessing arrangement according to the invention is explained in more detail below with reference to the drawing.

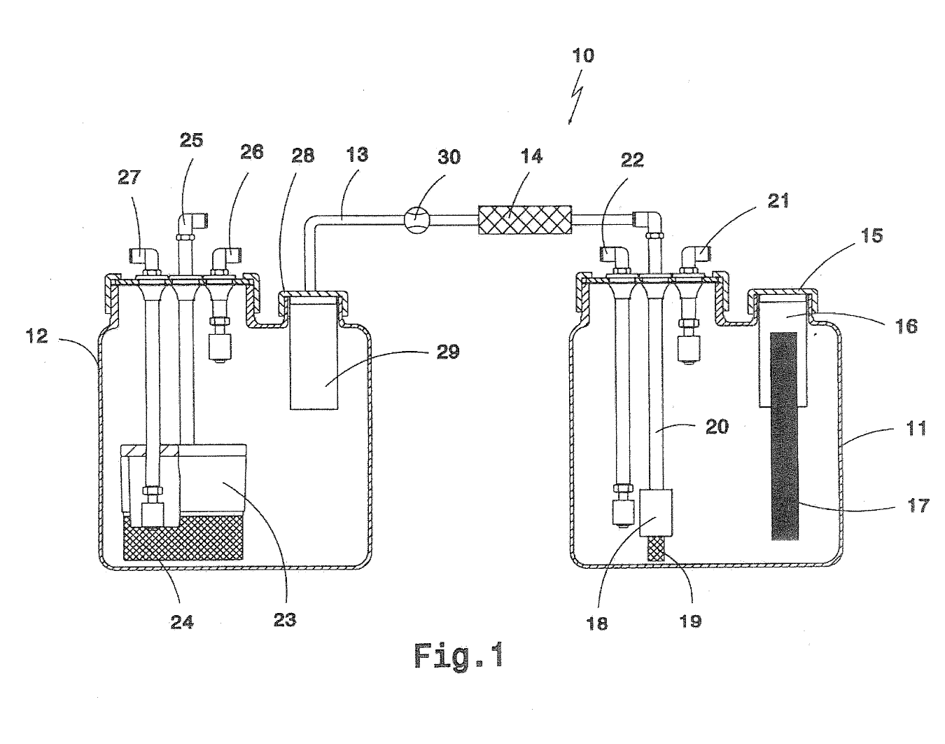

FIG. 1 is a schematic representation of a first used oil reprocessing arrangement;

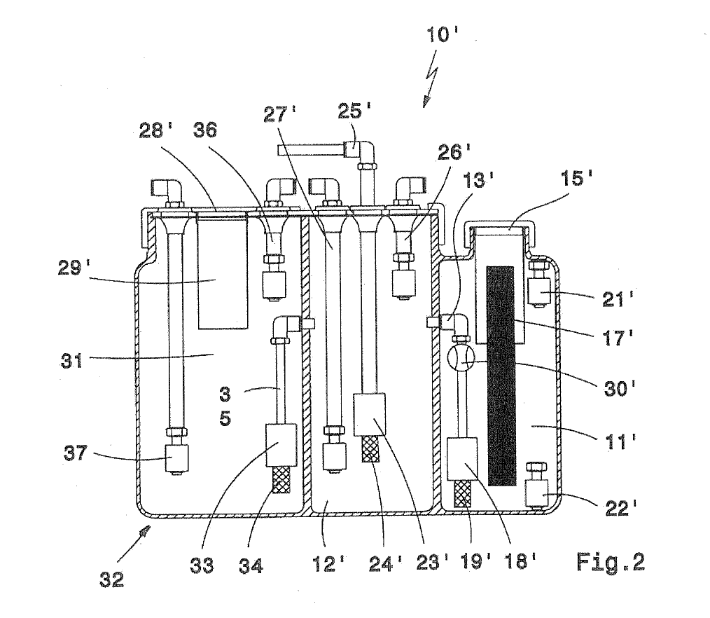

FIG. 2 is a schematic representation of a second used oil reprocessing arrangement.

FIG. 1 shows a used oil reprocessing arrangement 10 with a used oil collection container 11 and a fresh oil container 12. The two containers 11 and 12 are connected to one another via a connecting conduit 13. The connecting conduit 13 is directed via a filter device 14.

The used oil coming from a circular knitting machine (not shown in further detail here) passes drop by drop into the used oil collection container 11 through an inlet 15. A coarse filter 16 for filtering out coarse particles and also a magnetic rod 17 for separating metal components out of the used oil are arranged in the region of the inlet 15. In addition, the used oil collection container 11 has an oil feed pump 18, which aspirates the used oil via a fine filter 19 and feeds it via a riser 20 to the connecting conduit 13 with the filter device 14. Moreover, a level meter, which here comprises a sensor 21 for a maximum oil level and a sensor 22 for a minimum oil level, is arranged in the container 11. The sensors 11, 12 are connected to a control device (not shown in more detail), with which the pump 18 can be actuated.

An oil feed pump 23 is also arranged in the fresh oil container 12, which aspirates the new oil via a fine filter system 24 and transports it to an outlet 25, which can be connected to the knitting machine, for example, via a hose (not shown). The pump 23 is connected to the control device, as is a level meter comprising a sensor 26 for the maximum oil level and a sensor 27 for a minimum oil level. In addition, an inlet 28 is provided on the fresh oil container 12 for replenishing with new oil to replace the used oil consumed by the knitting machine. The connecting conduit 13 is also directed through this inlet 28. A coarse filter 29 is provided in the region of the inlet 28 in order to prevent contaminants from entering the container 12 when manually replenishing with new oil.

As soon as the sensor 21 in the used oil collection container 11 detects that the maximum oil level has been reached, the pump 18 that feeds used oil to the fresh oil container 12 via the filter device 14 and the connecting conduit is activated by means of the control device. A flow monitoring device 30, which detects clogging of the filter device 14 and in such a case stops the pump 18 by means of the control device, is provided in the connecting conduit in this case. If the sensor 26 detects that the maximum oil level has been reached in the fresh oil container 12, the pump 18 is also stopped by the control device. Therefore, the sensors 21 and 26 serve to prevent the containers 11 and 12 from overflowing. However, the sensors 22 and 27 for a minimum oil level in the containers 11 and 12, in cooperation with the control device, prevent pumps 18 and 23 from running empty.

The level meter in particular in the fresh oil container 12 could also measure the oil level precisely. This would enable the mixture ratio between reprocessed used oil and replenished new oil in the fresh oil container to always be kept constant. A specific percentage of new oil is necessary since the additives contained in the oil are lost during the used oil reprocessing.

The used oil reprocessing arrangement 10 has two containers 11 and 12 that can be mounted in the circular knitting machine independently of one another so that they can be easily retrofitted on existing circular knitting machines.

In contrast to the used oil reprocessing arrangement 10, the used oil reprocessing arrangement 10′ shown in FIG. 2 has only a single container 32. The used oil collection container 11′ and the fresh oil container 12′ are configured as separate chambers of the container 32. In addition, a third container 31 for new oil is integrated as a chamber in the container 32.

The used oil coming from the circular knitting machine is fed to the used oil collection container 11′ via an inlet 15′. A magnetic rod 17′ is again arranged downstream of this to separate metal particles. The connecting conduit 13′ to the fresh oil container 12′ and also a filter device 14′ and a flow meter 30′ are now arranged inside the used oil collection container 11′ in the processing arrangement 10′. The used oil is again aspirated via a pump 18′ and a fine filter 19′ and directed into the fresh oil container 12′. In addition, sensors 21′ and 22′ for a maximum and a minimum oil level are again provided in the used oil collection container.

Besides sensors 26′ and 27′ for a maximum and the minimum oil level, an oil feed pump 23′ is arranged in the fresh oil container 12′, which aspirates the new oil via a fine filter 24′ and feeds it to the circular knitting machine via an outlet 25′.

The third container 31 for new oil has an inlet 28′ for manually replenishing new oil. A coarse filter 29′ is connected downstream of this. In addition, an oil feed pump 33 is provided that aspirates the new oil via a fine filter 34 and directs it to the fresh oil container 12′ via a pipe connection 35. Moreover, the container 31 has sensors 36, 37 for a maximum and a minimal oil level.

The control of the oil flow between the used oil collection container 11′ and the fresh oil container 12′ is the same as in the used oil reprocessing arrangement 10 from FIG. 1. However, the supply of new oil from the container 31 into the fresh oil container is additionally controlled in dependence on the signal of the flow meter 30′ in such a manner that a constant ratio of reprocessed used oil and new oil is always present in the fresh oil container 12′. As a result, it can be assured that the new oil fed to the circular knitting machine always contains sufficient additive.

1. A used oil reprocessing arrangement for use with a circular knitting machine, comprising:
a used oil collection container for collecting used oil from the circular knitting machine;
a storage container for filtered used oil and new oil;
a connecting conduit arranged between the used oil collection container and the storage container;
a first oil feed pump arranged in the used oil collection container;
a control device; and
at least one filter device;
level meters provided in the used oil collection container and in the storage container;
wherein the level meters are connected to the control device; and
wherein the control device controls activation and deactivation of the first oil feed pump.

2. The used oil reprocessing arrangement according to claim 1, wherein the connecting conduit is directed via the at least one filter device.

3. The used oil reprocessing arrangement according to claim 1, wherein the used oil collection container and the storage container are configured as separate chambers of a joint container.

4. The used oil reprocessing arrangement according to claim 1, wherein a coarse filter for the collected used oil of the knitting machine is arranged at an inlet of the used oil collection container.

5. The used oil reprocessing arrangement according to claim 1, wherein at least one magnet is arranged in the used oil collection container to separate the metal components in the used oil.

6. The used oil reprocessing arrangement according to claim 5, wherein one or more magnetic rods are arranged in a region of the inlet of the used oil collection container.

7. The used oil reprocessing arrangement according to claim 1, wherein the first oil feed pump of the used oil collection container aspirates the used oil through a fine filter.

8. The used oil reprocessing arrangement according to claim 1, wherein a second oil feed pump is arranged in the storage container to feed the used oil, the new oil, or both, to the knitting machine

9. The used oil reprocessing arrangement according to claim 1, wherein the storage container has an inlet with a coarse filter downstream for manually replenishing with the new oil.

10. The used oil reprocessing arrangement according to claim 8, wherein a flow monitoring device is arranged in the connecting conduit.

11. The used oil reprocessing arrangement according to claim 8, wherein the control device activates the first oil feed pump of the used oil collection container if one of the level meters provided therein detects that a maximum value for the used oil level has been reached in the used oil collection container.

12. The used oil reprocessing arrangement according to claim 8, wherein the first oil feed pump of the used oil collection container is deactivated by the control device if the level meter in the storage container detects that a maximum value for the oil level in the storage container has been exceeded.

13. The used oil reprocessing arrangement according to claim 10, wherein the control device deactivates the first oil feed pump of the used oil collection container if the flow monitoring device detects no or only a very small amount of oil flow in the connecting conduit.

14. The used oil reprocessing arrangement according to claim 1, wherein the control device deactivates the first oil feed pump and the second oil feed pump of the used oil collection container and the storage container, if one of the level meters in the respective used oil collection container and the storage container detects that the oil level has gone below a minimum value.

15. The used reprocessing arrangement according to claim 1, further comprising a a new oil container, with new oil, wherein the new oil container is connected to the storage container and wherein the new oil container includes a third an oil feed pump connected to the control device.

16. The used-oil reprocessing arrangement according to claim 15, wherein the control device activates the third oil feed pump in the new oil container to (31) in such a manner that there is constantly maintain more new oil than used oil in the storage container and wherein an addition of used oil from the used oil collection container and new oil from the new oil container is measurable by a flow monitoring device.

17. A circular knitting machine with a used oil reprocessing arrangement according to claim 1, wherein the used oil reprocessing arrangement is arranged on a frame of the circular knitting machine.

18. The circular knitting machine according to claim 17, wherein the used oil feed arrangement is retrofitted to the circular knitting machine.
